(19) United States
(12) Patent Application Publication
(10) Pub. No.: US 2024/0207784 A1
(43) Pub. Date: Jun. 27, 2024

(54) CARBON DIOXIDE RECOVERY SYSTEM AND CARBON DIOXIDE RECOVERY METHOD

(71) Applicant: IHI Corporation, Tokyo (JP)

(72) Inventors: Kentaro SATO, Tokyo (JP); Michinori NARISAWA, Tokyo (JP)

(73) Assignee: IHI Corporation, Tokyo (JP)

(21) Appl. No.: 18/599,368

(22) Filed: Mar. 8, 2024

Related U.S. Application Data
(63) Continuation of application No. PCT/JP2022/042436, filed on Nov. 15, 2022.

(30) Foreign Application Priority Data
Nov. 24, 2021 (JP) 2021-190128

(51) Int. Cl. B01D 53/75; B01D 53/34; B01D 53/62; B01D 53/82; B01D 53/96

(52) U.S. Cl. CPC B01D 53/75; B01D 53/346; B01D 53/62; B01D 53/82; B01D 53/96; B01D 2253/202; B01D 2257/504; B01D 2258/06; B01D 2259/40086; B01D 2259/40088; B01D 2259/402

(57) ABSTRACT

Provided is a carbon dioxide recovery system including a first adsorption tower that contains a first adsorbent and a second adsorption tower that contains a second adsorbent. When brought into contact with a first concentrated gas supplied from the first adsorption tower, the second adsorbent adsorbs carbon dioxide in the first concentrated gas. When heated by a second heating unit, the second adsorbent desorbs carbon dioxide which has been adsorbed thereon, and a second concentrated gas that contains carbon dioxide desorbed from the second adsorbent and has a carbon dioxide concentration higher than that of the first concentrated gas is generated.

### CROSS REFERENCE TO RELATED APPLICATIONS

This application is a continuation application of International Application No. PCT/JP2022/042436, filed on Nov. 15, 2022, which claims priority to Japanese Patent Application No. 2021-190128, filed on Nov. 24, 2021, the entire contents of which are incorporated by reference herein.

### BACKGROUND

### 1. Technical Field

The present disclosure relates to a carbon dioxide recovery system and a carbon dioxide recovery method.

### 2. Description of the Related Art

Carbon dioxide has been regarded as a cause of global warming, and a movement to control the rise in carbon dioxide concentration has been spreading worldwide. A technique called direct air capture (DAC) has been proposed as one of the methods to reduce carbon dioxide concentration in the atmosphere. DAC is a technique to directly capture carbon dioxide from the air. The carbon dioxide captured using the DAC can be stored underground and the like and can also be used as a raw material for various compounds.

Japanese Patent No. 6622302 discloses a method for separating carbon dioxide from air through cyclic adsorption/desorption using an adsorbent. The method includes an adsorption step in which carbon dioxide is adsorbed on the adsorbent and a desorption step in which carbon dioxide is desorbed from the adsorbent. In the desorption step, the inside of the unit is evacuated until it becomes a vacuum state.

### SUMMARY

In the DAC, carbon dioxide is directly adsorbed from air, and thus a large amount of air is taken into the unit. Thus, conventional DAC units are large and may require a lot of energy to reduce the pressure inside the unit until it reaches a vacuum state.

An object of the present disclosure is to provide a carbon dioxide recovery system and a carbon dioxide recovery method capable of reducing the energy required for depressurization when carbon dioxide is desorbed from an adsorbent.

A carbon dioxide recovery system according to the present disclosure includes: a first adsorption tower that contains a first adsorbent and includes a first heating unit for heating the first adsorbent; and a second adsorption tower that contains a second adsorbent and includes a second heating unit for heating the second adsorbent. When brought into contact with air supplied from outside of the first adsorption tower, the first adsorbent adsorbs carbon dioxide in the air and when heated by the first heating unit, desorbs carbon dioxide which has been adsorbed thereon, and a first concentrated gas that contains carbon dioxide desorbed from the first adsorbent and has a carbon dioxide concentration higher than that of the air is generated. When brought into contact with the first concentrated gas supplied from the first adsorption tower, the second adsorbent adsorbs carbon dioxide in the first concentrated gas and when heated by the second heating unit, desorbs carbon dioxide which has been adsorbed thereon, and a second concentrated gas that contains carbon dioxide desorbed from the second adsorbent and has a carbon dioxide concentration higher than that of the first concentrated gas is generated.

The second adsorption tower may have a smaller volume than that of the first adsorption tower.

The carbon dioxide recovery system may further include a depressurization unit that depressurizes the inside of the second adsorption tower.

The carbon dioxide recovery system may further include a gas supply unit that supplies to the second adsorption tower at least one type of purge gas selected from the group consisting of air, hydrogen, water vapor, and an inert gas.

The bulk density of the second adsorbent may be greater than or equal to that of the first adsorbent.

The bulk density of the second adsorbent may be less than that of the first adsorbent.

The carbon dioxide recovery system may further include a concentration measuring unit that measures a concentration of carbon dioxide in the first concentrated gas, wherein the first concentrated gas discharged from the first adsorption tower may be introduced into the first adsorption tower in accordance with the concentration of carbon dioxide measured by the concentration measuring unit.

A method for recovering carbon dioxide includes a step of causing, through contact with air supplied from outside of a first adsorption tower, carbon dioxide in the air to be adsorbed on a first adsorbent contained in the first adsorption tower, a step of causing carbon dioxide which has been adsorbed on the first adsorbent to be desorbed through heating and generating a first concentrated gas that contains carbon dioxide desorbed from the first adsorbent and has a carbon dioxide concentration higher than that of the air, a step of causing, through contact with the first concentrated gas supplied from the first adsorption tower, carbon dioxide in the first concentrated gas to be adsorbed on a second adsorbent contained in a second adsorption tower, and a step of causing carbon dioxide which has been adsorbed on the second adsorbent to be desorbed through heating and generating a second concentrated gas that contains carbon dioxide desorbed from the second adsorbent and has a carbon dioxide concentration higher than that of the first concentrated gas.

The present disclosure provides a carbon dioxide recovery system and a carbon dioxide recovery method capable of reducing energy required for depressurization when carbon dioxide is desorbed from an adsorbent.

### BRIEF DESCRIPTION OF THE DRAWINGS

FIG. 1 is a schematic diagram illustrating a carbon dioxide recovery system according to one embodiment.

FIG. 2 is a schematic diagram illustrating an example of a state in which air is introduced into a first adsorption tower.

FIG. 3 is a schematic diagram illustrating an example of a state in which carbon dioxide that has been adsorbed on a first adsorbent is desorbed through heating.

FIG. 4 is a schematic diagram illustrating an example of a state in which a first concentrated gas generated in the first adsorption tower is re-introduced into the first adsorption tower.

FIG. 5 is a schematic diagram illustrating an example of a state in which the first concentrated gas is introduced into a second adsorption tower.

FIG. 6 is a schematic diagram illustrating an example of a state in which carbon dioxide that has been adsorbed on a second adsorbent is desorbed through heating.

FIG. 7 is a schematic diagram illustrating an example of a state in which a second concentrated gas generated in a second adsorption tower is recovered.

FIG. 8 is an explanatory diagram for explaining a mechanism for increasing the carbon dioxide concentration through two-step adsorption and desorption.

### DESCRIPTION OF THE EMBODIMENTS

Some exemplary embodiments will be described with reference to the drawings. Note that dimensional ratios in the drawings are exaggerated for convenience of the description and are sometimes different from actual ratios.

### Carbon Dioxide Recovery System

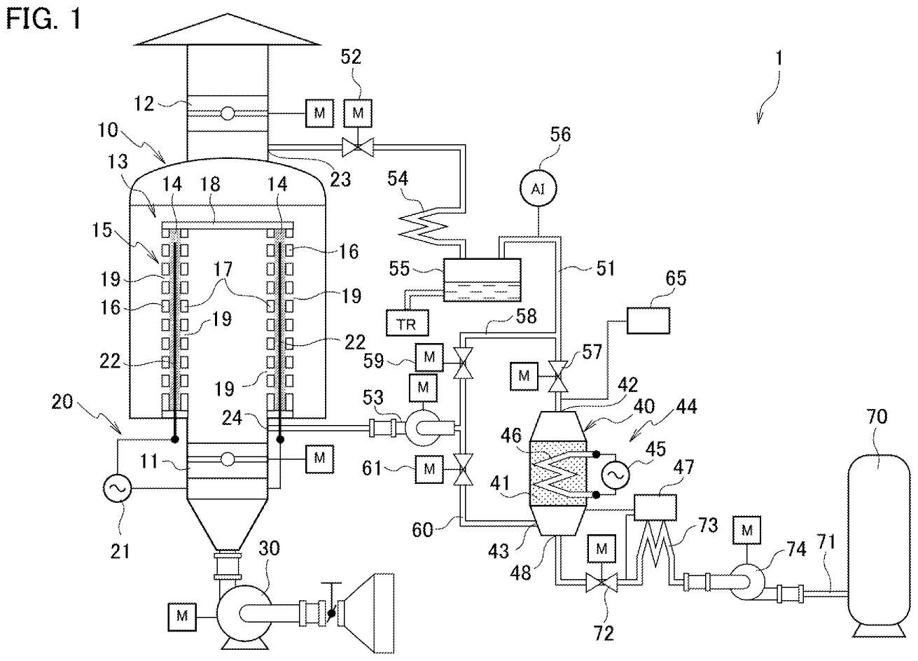

As illustrated in FIG. 1, a carbon dioxide recovery system 1 according to the present embodiment includes a first adsorption tower 10, an air supply unit 30, a second adsorption tower 40, and a recovery unit 70. In the carbon dioxide recovery system 1 according to the present embodiment, carbon dioxide in the air is adsorbed in the first adsorption tower 10, and carbon dioxide adsorbed in the first adsorption tower 10 is concentrated and recovered in the second adsorption tower 40. Each component will be described in detail below.

The first adsorption tower 10 is provided with an inlet 11 for introducing air into the first adsorption tower 10 and an outlet 12 for discharging the air in the first adsorption tower 10. The inlet 11 and the outlet 12 are provided with a damper. The air supply unit 30 is connected to the inlet 11 and supplies air into the first adsorption tower 10. The air supply unit 30 may be a blower. When the inlet 11 and outlet 12 are opened, external air is introduced into the first adsorption tower 10 from the inlet 11. The introduced air is brought into contact with a first adsorbent 14 contained in the first adsorption tower 10, and then is discharged from the outlet 12.

Note that the air supply unit 30 may be connected to the outlet 12, not to the inlet 11, and by reducing pressure in the first adsorption tower 10, air may be supplied from the inlet 11 into the first adsorption tower 10. In the carbon dioxide recovery system 1 according to the present embodiment, by forcibly supplying air to the first adsorption tower 10 using the air supply unit 30, the first adsorbent 14 is brought into contact with the air. However, air may be supplied to the first adsorption tower 10 through natural ventilation instead of using the air supply unit 30.

The first adsorption tower 10 contains a first adsorption part 13. The first adsorption part 13 is spaced apart from a side wall part of the first adsorption tower 10. The first adsorption part 13 includes the first adsorbent 14 and a support part 15 for supporting the first adsorbent 14. The support part 15 includes a cylindrical outer wall 16 and a cylindrical inner wall 17 having a smaller diameter than that of the outer wall 16. The first adsorbent 14 is filled between the outer wall 16 and the inner wall 17, and the first adsorbent 14 is supported by the support part 15 so as to have a cylindrical shape. An opening at one end of the cylindrical support part 15 is connected to the inlet 11, and an opening at the other end is closed by a top plate 18. Multiple holes 19 are provided in the outer wall 16 and the inner wall 17. Thus, the air introduced from the inlet 11 passes through the support part 15 while contacting with the first adsorbent 14 from the inner wall 17 side toward the outer wall 16 side.

Note that the first adsorbent 14 having a cylindrical shape is arranged to extend in the vertical direction, but may be arranged to extend in the horizontal direction. In the present embodiment, air is passed from the inner wall 17 side toward the outer wall 16 side, but air may be passed from the outer wall 16 side toward the inner wall 17 side. The shape of the first adsorbent 14 is not limited to a cylinder but may be a circular flat plate or a rectangular flat plate.

When the first adsorbent 14 comes into contact with air supplied from the outside of the first adsorption tower 10, the first adsorbent 14 adsorbs carbon dioxide in the air. The first adsorbent 14 may contain at least one selected from the group consisting of a porous body, an alkali metal, and an alkaline earth metal. These materials can efficiently adsorb carbon dioxide. The porous body may contain at least one selected from the group consisting of zeolite, alumina, silica, resin, clay, and activated carbon. The first adsorbent 14 containing the alkali metal may contain at least one of an alkali metal carbonate and a lithium transition metal complex oxide. The first adsorbent 14 containing the alkaline earth metal may contain an alkaline earth metal oxide or the like.

The first adsorbent 14 may include at least one of a porous body with a basic substance supported on the surface, and a porous body with the surface modified with a base. Such a material has a large specific surface area and high reactivity of the base to carbon dioxide, making it possible to adsorb a large amount of carbon dioxide. As the porous body, those described above may be used. The basic material may include at least one type of amine compound selected from the group consisting of a primary amine compound, a secondary amine compound, and a tertiary amine compound. The base for modifying the surface of the porous body may be an amino group. These materials can be obtained by soaking a porous body in an amine compound described above, drying it, and causing a basic substance to be supported on the surface of the porous body or modifying the surface of the porous body with a base. Alternatively, these materials can be obtained by modifying a porous body with a basic substance using a chemical reaction such as a dealcoholization reaction between the surface of the porous body and an amine compound.

The first adsorption tower 10 includes a first heating unit 20 for heating the first adsorbent 14. When heated by the first heating unit 20, the first adsorbent 14 desorbs carbon dioxide which has been adsorbed on the first adsorbent 14. Thus, the first adsorbent 14 generates a first concentrated gas containing the carbon dioxide desorbed from the first adsorbent 14 and having a higher carbon dioxide concentration than that of the air supplied from the outside of the first adsorption tower 10. The first adsorption tower 10 is provided with an outlet 23 for discharging the first concentrated gas, and the first concentrated gas is discharged from the first adsorption tower 10 through the outlet 23 and introduced into the second adsorption tower 40.

The first heating unit 20 includes a power source 21 and a heating element 22 electrically connected to the power source 21. A current flows through the heating element 22 from the power source 21, and thus the heating element 22 generates heat. The heating element 22 is embedded in the first adsorbent 14. It is sufficient that the heating element 22 can heat the first adsorbent 14, and the heating element 22 may be provided to surround the first adsorption part 13. The first heating unit 20 may include at least one selected from the group consisting of a band heater, a film heater, a plate heater, a sheath heater, a tube heater, a hose heater, a plug heater, and a flange heater. The first heating unit 20 may heat the first adsorbent 14 by passing a heat medium such as vapor through a conduit. The first heating unit 20 may heat the first adsorbent 14 using at least one selected from the group consisting of induction heating, resistance heating, microwave heating, and millimeter wave heating.

The second adsorption tower 40 is provided with an inlet 42 for introducing the first concentrated gas. The outlet 23 of the first adsorption tower 10 and the inlet 42 of the second adsorption tower 40 are connected through piping 51. In the piping 51, an opening and closing valve 52, a first cooling part 54, a separation unit 55, a concentration measuring unit 56, and an opening and closing valve 57 are provided in this order from the first adsorption tower 10. Piping 58 branches from the piping 51 between the concentration measuring unit 56 and the second adsorption tower 40, and is connected to an inlet 24 provided in the first adsorption tower 10. The piping 58 is provided with an opening and closing valve 59 and a blower 53. An outlet 43 of the second adsorption tower 40 and the inlet 24 of the first adsorption tower 10 are connected through piping 60. The piping 60 is provided with an opening and closing valve 61. An outlet 48 of the second adsorption tower 40 and the recovery unit 70 are connected through piping 71. The piping 71 is provided with an opening and closing valve 72.

The blower 53 sucks the first concentrated gas in the first adsorption tower 10 so that the first concentrated gas flows through the piping 51. When the opening and closing valve 52 and the opening and closing valve 59 are opened and the opening and closing valve 57 and the opening and closing valve 61 are closed, the blower 53 introduces the first concentrated gas from the inlet 24 to the first adsorption tower 10. When the opening and closing valve 52, the opening and closing valve 57, and the opening and closing valve 61 are opened and the opening and closing valve 59 and the opening and closing valve 72 are closed, the blower 53 introduces the first concentrated gas to the second adsorption tower 40.

The first cooling part 54 cools the first concentrated gas. By cooling the first concentrated gas in the first cooling part 54, the moisture in the first concentrated gas is condensed.

The separation unit 55 recovers the moisture condensed in the first cooling part 54 from the first concentrated gas. By removing the moisture from the first concentrated gas, the dried first concentrated gas can be supplied to the second adsorption tower 40. The separation unit 55 may include a drain tank. The drain tank may be provided with a thermometer, and the temperature of water condensed in the drain tank may be measured.

The concentration measuring unit 56 measures the concentration of carbon dioxide in the first concentrated gas. The first concentrated gas discharged from the first adsorption tower 10 may be introduced into the first adsorption tower 10 in accordance with the carbon dioxide concentration measured using the concentration measuring unit 56. By introducing the first concentrated gas into the first adsorption tower 10 without going through the second adsorption tower 40, desorption of carbon dioxide which has been still adsorbed on the first adsorbent 14 can be promoted, and the concentration of carbon dioxide in the first concentrated gas can be increased. For example, when the concentration of carbon dioxide is lower than a predetermined concentration, the first concentrated gas may be introduced into the first adsorption tower 10, and when the concentration of carbon dioxide is higher than a predetermined concentration, the first concentrated gas may be introduced into the second adsorption tower 40. When it has been confirmed through prior experiments that the concentration of carbon dioxide in the first concentrated gas is higher than a desired concentration, the first concentrated gas may be introduced into the second adsorption tower 40 without measuring the concentration.

The second adsorption tower 40 contains a second adsorbent 41. The second adsorbent 41 adsorbs carbon dioxide in the first concentrated gas when brought into contact with the first concentrated gas supplied from the first adsorption tower 10. The second adsorbent 41 may be filled in the flow path for the first concentrated gas. The second adsorbent 41 may have a structure such as a flat plate, a cylinder, a polygonal cylinder, an indeterminate shape, a powder, particles, a sphere, an ellipsoid, a cone, or a polygonal pyramid. As the second adsorbent 41, those listed as examples of the first adsorbent 14 can be used. The first adsorbent 14 and the second adsorbent 41 may be of the same type or different types.

The second adsorption tower 40 is provided with the outlet 43 for discharging the first concentrated gas which has come into contact with the second adsorbent 41. The outlet 43 of the second adsorption tower 40 and the inlet 24 of the first adsorption tower 10 are connected through the piping 60. By supplying the first concentrated gas which has come into contact with the second adsorbent 41 to the first adsorption tower 10 through the piping 60, the amount of carbon dioxide transferred from the first adsorbent 14 to the second adsorbent 41 can be increased.

The exposed area of the second adsorbent 41 on the inlet 42 side may be smaller than that of the first adsorbent 14 on the inlet 11 side. As a result, the area where air comes into contact with the first adsorbent 14 at the inlet 11 side is larger than the area where the first concentrated gas comes into contact with the second adsorbent 41 at the inlet 42 side. Thus, the cross-sectional area of the flow path of air passing through the first adsorbent 14 is larger than the cross-sectional area of the flow path of the first concentrated gas passing through the second adsorption tower 40. Thus, the flow amount of air in the first adsorption tower 10 can be made larger than that in the second adsorption tower 40. In contrast, the flow rate of the first concentrated gas flowing to the second adsorption tower 40 can be set as a small flow rate, and the time for the first concentrated gas to come into contact with the second adsorbent 41 can be increased. Therefore, carbon dioxide can be easily concentrated in the second adsorption tower 40.

The bulk density of the second adsorbent 41 may be greater than or equal to that of the first adsorbent 14. When the bulk density of the second adsorbent 41 is greater than that of the first adsorbent 14, carbon dioxide can be made adsorbed on the second adsorbent 41 at a density higher than that of the first adsorbent 14. Thus, carbon dioxide can be concentrated more easily, thereby improving the recovery effect of carbon dioxide. In contrast, when the bulk density of the first adsorbent 14 is less than that of the second adsorbent 41, the pressure loss in the first adsorption tower 10 can be made lower than that in the second adsorption tower 40. Thus, the flow amount of air in the first adsorption tower 10 can be made greater than that in the second adsorption tower 40. In addition, when the bulk density of the second adsorbent 41 is equal to that of the first adsorbent 14, the same adsorbent can be provided, and thus the maintenance of the device is simplified without the need to prepare separate adsorbents. In contrast, the bulk density of the second adsorbent 41 may be less than that of the first adsorbent 14. Thus, the pressure loss of the second adsorbent 41 becomes small, and the power of the blower 53 can be reduced. Furthermore, by reducing the pressure of the second adsorption tower 40 and purging with water vapor, carbon dioxide can be efficiently recovered.

The carbon dioxide adsorption capacity of the second adsorbent 41 may be larger than or equal to that of the first adsorbent 14. In this case, much of the carbon dioxide adsorbed in the first adsorption tower 10 can be made adsorbed in the second adsorption tower 40. In contrast, the carbon dioxide adsorption capacity of the second adsorbent 41 may be less than that of the first adsorbent 14. In this case, since the carbon dioxide which has been adsorbed on the second adsorbent 41 tends to reach the saturation state, the carbon dioxide concentration ultimately obtained can be increased.

Note that the carbon dioxide adsorption capacity means the product of the carbon dioxide adsorption capacity per unit capacity of an adsorbent and the capacity of the adsorbent. That is, the carbon dioxide adsorption capacity of the first adsorbent 14 means the product of the carbon dioxide adsorption capacity per unit capacity [g_CO₂/L_adsorbent] of the first adsorbent 14 and the capacity [L_adsorbent] of the first adsorbent 14. Similarly, the carbon dioxide adsorption capacity of the second adsorbent 41 means the product of the carbon dioxide adsorption capacity per unit capacity [g_CO₂/L_adsorbent] of the second adsorbent 41 and the capacity [L_adsorbent] of the second adsorbent 41. Note that the adsorption capacity means the saturated adsorption capacity under the temperature and the carbon dioxide partial pressure in the adsorption atmosphere.

The capacity of the first adsorbent 14 may be greater than or equal to that of the second adsorbent 41. The concentration of carbon dioxide in the air to be introduced into the first adsorption tower 10 is about 400 ppm, which is lower than that of the first concentrated gas to be introduced into the second adsorption tower 40. Thus, the capacity of the first adsorbent 14 is made larger than that of the second adsorbent 41, and the surface area brought into contact with carbon dioxide is made larger than that of the second adsorbent 41, thereby increasing the recovery efficiency of carbon dioxide. The capacity of the first adsorbent 14 may be 2 times or more or 5 times or more than that of the second adsorbent 41.

The second adsorption tower 40 includes a second heating unit 44 for heating the second adsorbent 41. When heated by the second heating unit 44, the second adsorbent 41 desorbs carbon dioxide which has been adsorbed on the second adsorbent 41. Thus, the second adsorbent 41 generates a second concentrated gas containing the carbon dioxide desorbed from the second adsorbent 41 and having a higher carbon dioxide concentration than that of the first concentrated gas.

The second heating unit 44 includes a power source 45 and a heating element 46 electrically connected to the power source 45. A current flows through the heating element 46 from the power source 45, and thus the heating element 46 generates heat. The heating element 46 is embedded in the second adsorbent 41. It is sufficient that the heating element 46 can heat the second adsorbent 41, and the heating element 46 may be provided to surround the second adsorbent 41. The second heating unit 44 may include at least one selected from the group consisting of a band heater, a film heater, a plate heater, a sheath heater, a tube heater, a hose heater, a plug heater, and a flange heater. The second heating unit 44 may also heat the second adsorbent 41 by passing a heat medium such as vapor through a conduit. The second heating unit 44 may also heat the second adsorbent 41 using at least one selected from the group consisting of induction heating, resistance heating, microwave heating, and millimeter wave heating.

The carbon dioxide recovery system 1 may include a depressurization unit 47 for depressurizing the inside of the second adsorption tower 40. By depressurizing the inside of the second adsorption tower 40 before carbon dioxide adsorption, the amount of carbon dioxide adsorbed on the second adsorbent 41 can be increased. Further, by depressurizing the inside of the second adsorption tower 40 during carbon dioxide desorption, the desorption of carbon dioxide from the second adsorbent 41 can be promoted. Further, by depressurizing the inside of the second adsorption tower 40 during carbon dioxide desorption, residual gases other than carbon dioxide can be reduced and the concentration of carbon dioxide can be increased. The discharge side of the depressurization unit 47 may be connected to the piping 71 downstream of the opening and closing valve 72 and upstream of a second cooling unit 73 described later, and the obtained high-concentration carbon dioxide mixed gas may be pressurized.

The second adsorption tower 40 may have a smaller volume than that of the first adsorption tower 10. When the volume of the second adsorption tower 40 is smaller than the volume of the first adsorption tower 10, the inside of the second adsorption tower 40 can be reduced to a vacuum state with less energy than reducing the inside of the first adsorption tower 10. Furthermore, when the volume of the second adsorption tower 40 is smaller, the use of expensive specialized components such as valves and dampers necessary to ensure a vacuum state can be reduced.

The carbon dioxide recovery system 1 may include a gas supply unit 65 that supplies to the second adsorption tower 40 at least one type of purge gas selected from the group consisting of air, hydrogen, water vapor, and an inert gas. By supplying such a purge gas to the second adsorption tower 40, the desorption of carbon dioxide from the second adsorbent 41 can be promoted. The gas supply unit 65 may be connected, for example, between the opening and closing valve 57 and the second adsorption tower 40 in the piping 51.

When air is used as the purge gas, ambient air can be used, thereby reducing the cost required for carbon dioxide desorption. Since water vapor is condensed through cooling, when water vapor is used as the purge gas, carbon dioxide desorbed and moisture can be easily separated, thereby increasing the carbon dioxide concentration. Since the reaction activity of inert gases is low, when an inert gas is used as the purge gas, carbon dioxide can be recovered in a state containing the inert gas without using a special separator. When hydrogen is used as the purge gas, a gas mixture of hydrogen and carbon dioxide is obtained, and a synthesis gas to be used for the hydrogenation reaction of carbon dioxide can be generated. Thus, when hydrogen is used as the purge gas, raw materials for various reaction processes such as methanation can be obtained. When the recovered gas is used for methanation, for example, hydrogen may be supplied to the second adsorption tower 40 so that the volume amount of carbon dioxide relative to the hydrogen is 20% or more.

When the volume of the second adsorption tower 40 is smaller than that of the first adsorption tower 10, the second adsorption tower 40 may be purged with a smaller amount than that used for desorption in the first adsorption tower 10. Thus, the carbon dioxide concentration of the second concentrated gas can be made higher. In addition, when the volume of the second adsorption tower 40 is smaller than that of the first adsorption tower 10, the inside of the second adsorption tower 40 can be easily heated, and thus the energy for desorbing the carbon dioxide can be reduced. Furthermore, when water vapor is used as the purge gas, for example, the energy required for removing water vapor can be reduced.

The second adsorption tower 40 is provided with the outlet 48 for discharging the second concentrated gas. The outlet 48 of the second adsorption tower 40 and the recovery unit 70 are connected through the piping 71. The piping 71 is provided with the opening and closing valve 72, the second cooling unit 73, and a compressor 74 in this order.

The second cooling unit 73 cools the second concentrated gas passing through the piping 71. The compressor 74 compresses the second concentrated gas and supplies the compressed second concentrated gas to the recovery unit 70. A known compressor may be used for the compressor 74. The recovery unit 70 stores the second concentrated gas. The recovery unit 70 may be a tank. Note that the carbon dioxide recovery system 1 may not necessarily be provided with the recovery unit 70, and the second concentrated gas generated in the second adsorption tower 40 may be supplied to a reactor (not illustrated) and used directly as a reaction raw material.

The piping 71 may be provided with a concentration measuring unit (not illustrated) for measuring the concentration of carbon dioxide in the second concentrated gas. The second concentrated gas may be introduced into the first adsorption tower 10 in accordance with the concentration of carbon dioxide measured by the concentration measuring unit. For example, when the concentration of carbon dioxide is lower than a predetermined concentration, the second concentrated gas may be introduced into the first adsorption tower 10, and when the concentration of carbon dioxide is higher than a predetermined concentration, the second concentrated gas may be introduced into the recovery unit 70.

When the second concentrated gas is introduced into the first adsorption tower 10, the concentration of carbon dioxide in the second concentrated gas may be increased by concentrating it again in the second adsorption tower 40.

### Carbon Dioxide Recovery Method

Next, a carbon dioxide recovery method according to the present embodiment will be described. The carbon dioxide recovery method according to the present embodiment includes a first adsorption step, a first desorption step, a second adsorption step, and a second desorption step.

### (First Adsorption Step)

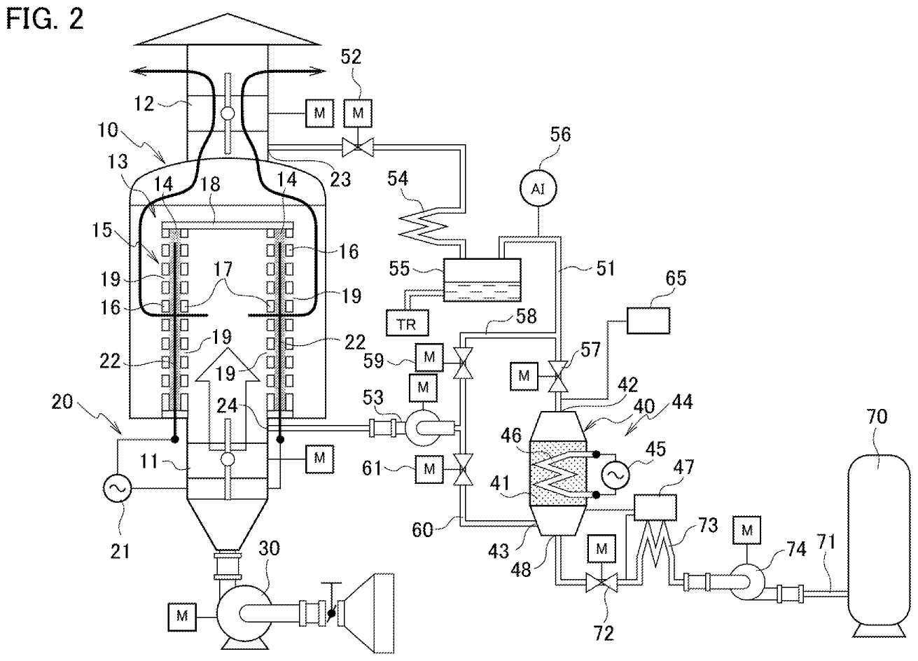

As illustrated in FIG. 2, in the first adsorption step, through contact with air supplied from the outside of the first adsorption tower 10, carbon dioxide in the air is adsorbed on the first adsorbent 14 contained in the first adsorption tower 10. Specifically, in the first adsorption step, the inlet 11 and the outlet 12 are opened, and the opening and closing valve 52, the opening and closing valve 59, and the opening and closing valve 61 are closed. The air outside the first adsorption tower 10 is supplied to the first adsorption tower 10 from the inlet 11 by the air supply unit 30. The air supplied to the first adsorption tower 10 is discharged from the first adsorption tower 10 through the outlet 12 after contacting with the first adsorbent 14. The temperature in the first adsorption tower 10 in the first adsorption step is not particularly limited and may be at normal temperature. The pressure in the first adsorption tower 10 in the first adsorption step is not particularly limited and may be at normal pressure.

### (First Desorption Step)

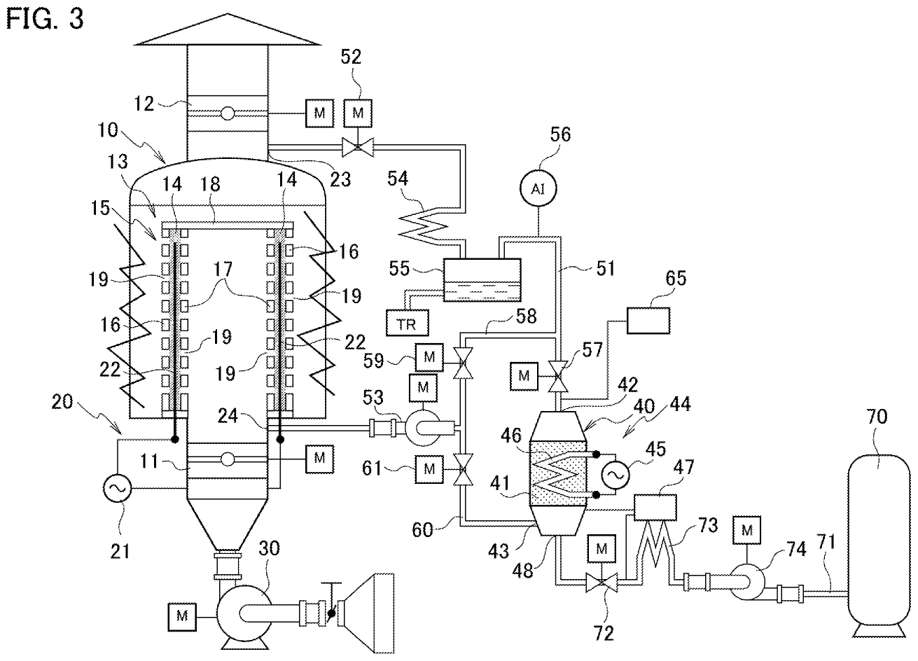

As illustrated in FIG. 3, in the first desorption step, carbon dioxide which has been adsorbed on the first adsorbent 14 is desorbed through heating, and a first concentrated gas is generated which contains the carbon dioxide desorbed from the first adsorbent 14 and has a carbon dioxide concentration higher than that of the air. When the pressure is the same, the amount of carbon dioxide adsorbed on the first adsorbent 14 decreases as the temperature increases. Thus, by heating the first adsorbent 14, carbon dioxide is desorbed from the first adsorbent 14, and the first concentrated gas is generated which contains the carbon dioxide desorbed from the first adsorbent 14 and has a carbon dioxide concentration higher than that of the air.

Specifically, in the first desorption step, the inlet 11, the outlet 12, the opening and closing valve 52, the opening and closing valve 59, and the opening and closing valve 61 are closed, and the first adsorbent 14 is heated by the first heating unit 20. When the first concentrated gas is generated, the opening and closing valve 52 is opened, and the first concentrated gas is discharged from the first adsorption tower 10 through the outlet 23. Desorption of carbon dioxide may be promoted by supplying air into the first adsorption tower 10 using the air supply unit 30. The first concentrated gas passes through the piping 51 and is introduced into the second adsorption tower 40 from the inlet 42.

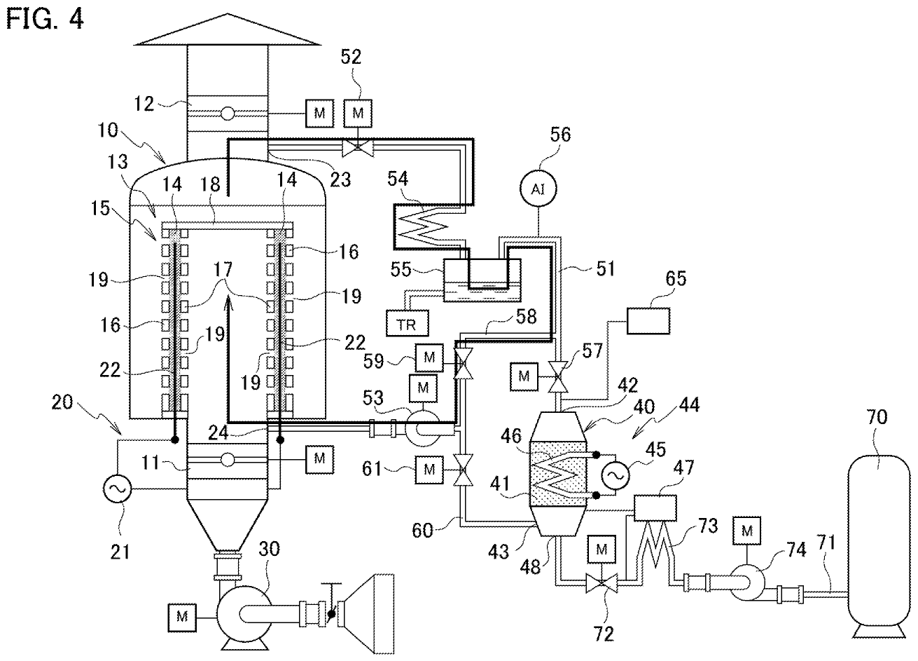

As illustrated in FIG. 4, in the first desorption step, the first concentrated gas may be introduced into the first adsorption tower 10 in accordance with the concentration of carbon dioxide measured by the concentration measuring unit 56. For example, when the concentration of carbon dioxide in the first concentrated gas is lower than a predetermined concentration, the first concentrated gas may be introduced into the first adsorption tower 10. Specifically, when the concentration of carbon dioxide in the first concentrated gas is lower than a predetermined concentration, the opening and closing valve 52 and the opening and closing valve 59 are opened, and the opening and closing valve 57 and the opening and closing valve 61 are closed. Thus, since the first concentrated gas passes through the first adsorption tower 10 again, desorption of the carbon dioxide which has been still adsorbed on the first adsorbent 14 is promoted, and the carbon dioxide concentration in the first concentrated gas can be increased. The first concentrated gas may pass through the first adsorption tower 10 repeatedly. The first concentrated gas may pass through the first adsorption tower 10 multiple times, for example, three or more times. When the concentration of carbon dioxide in the first concentrated gas is greater than or equal to a predetermined concentration, the first concentrated gas may be introduced into the second adsorption tower 40.

### (Second Adsorption Step)

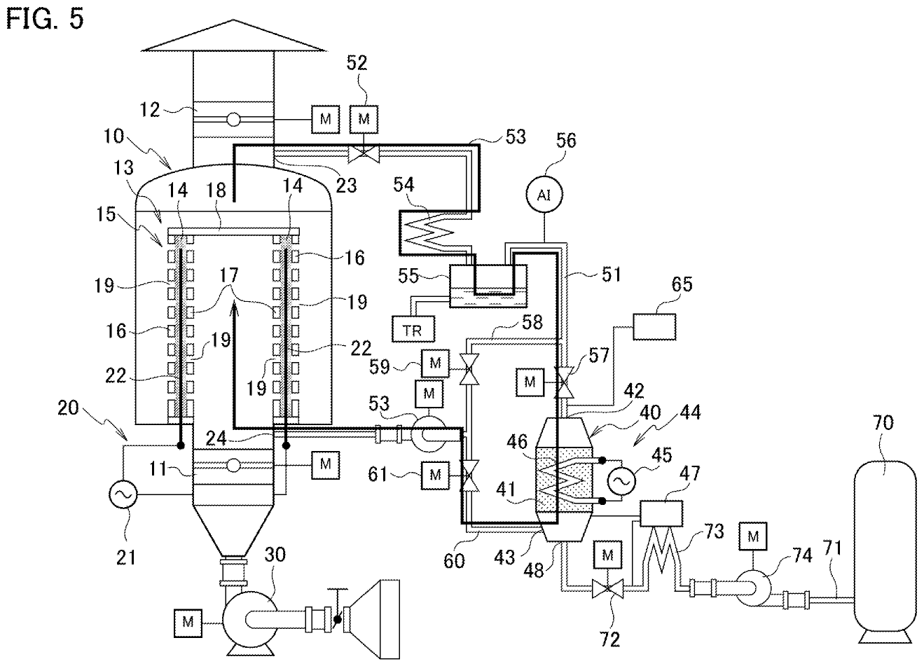

In the second adsorption step, through contact with the first concentrated gas supplied from the first adsorption tower 10, carbon dioxide in the first concentrated gas is adsorbed on the second adsorbent 41 contained in the second adsorption tower 40. As illustrated in FIG. 5, in the second adsorption step, the first concentrated gas which has come into contact with the second adsorbent 41 may be supplied to the first adsorption tower 10. In this case, the opening and closing valve 52, the opening and closing valve 57, and the opening and closing valve 61 are opened, and the inlet 11, the outlet 12, the opening and closing valve 59, and the opening and closing valve 72 are closed. By supplying the first concentrated gas to the first adsorption tower 10 again, the amount of carbon dioxide transferred from the first adsorbent 14 to the second adsorbent 41 can be increased.

That is, the first concentrated gas which has come into contact with the second adsorbent 41 is introduced into the first adsorption tower 10 through the piping 60 and comes into contact with the first adsorbent 14. Since the carbon dioxide concentration of the gas supplied to the first adsorption tower 10 is reduced due to the adsorption of carbon dioxide on the second adsorbent 41, the gas which has come into contact with the first adsorbent 14 promotes desorption of the carbon dioxide which has been still adsorbed on the first adsorbent 14. The first concentrated gas which has come into contact with the first adsorbent 14 is supplied again to the second adsorption tower 40, and carbon dioxide in the first concentrated gas is adsorbed on the second adsorbent 41.

### (Second Desorption Step)

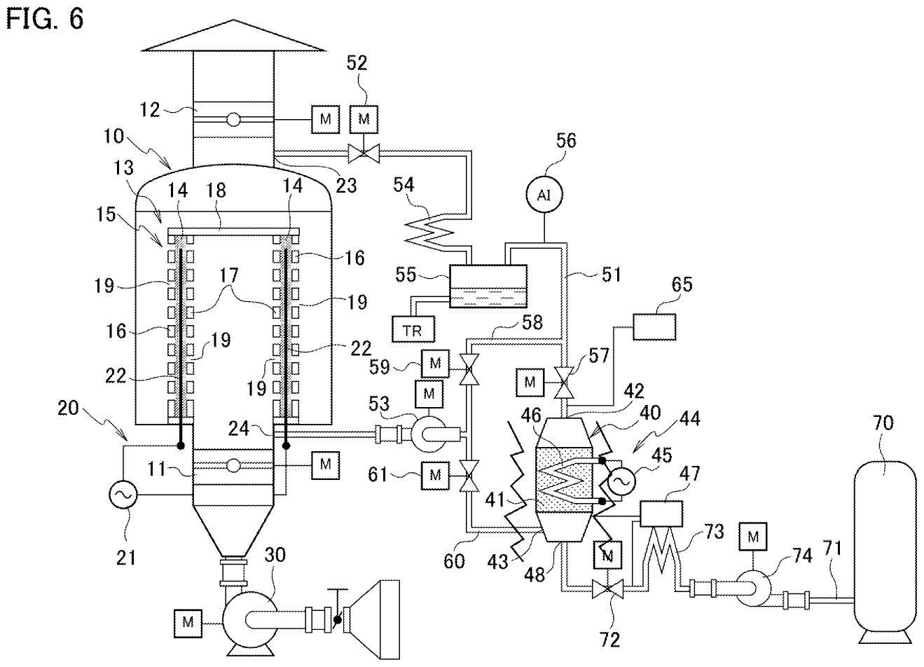

As illustrated in FIG. 6, in the second desorption step, carbon dioxide which has been adsorbed on the second adsorbent 41 is desorbed through heating, and a second concentrated gas is generated which contains carbon dioxide desorbed from the second adsorbent 41 and has a higher carbon dioxide concentration than that of the first concentrated gas. In the second desorption step, the opening and closing valve 57, the opening and closing valve 61, and the opening and closing valve 72 are closed, and the second adsorbent 41 is heated by the second heating unit 44. As the second adsorbent 41 is heated, carbon dioxide is desorbed from the second adsorbent 41, and the second concentrated gas is generated which contains carbon dioxide desorbed from the second adsorbent 41 and has a higher carbon dioxide concentration than that of the first concentrated gas.

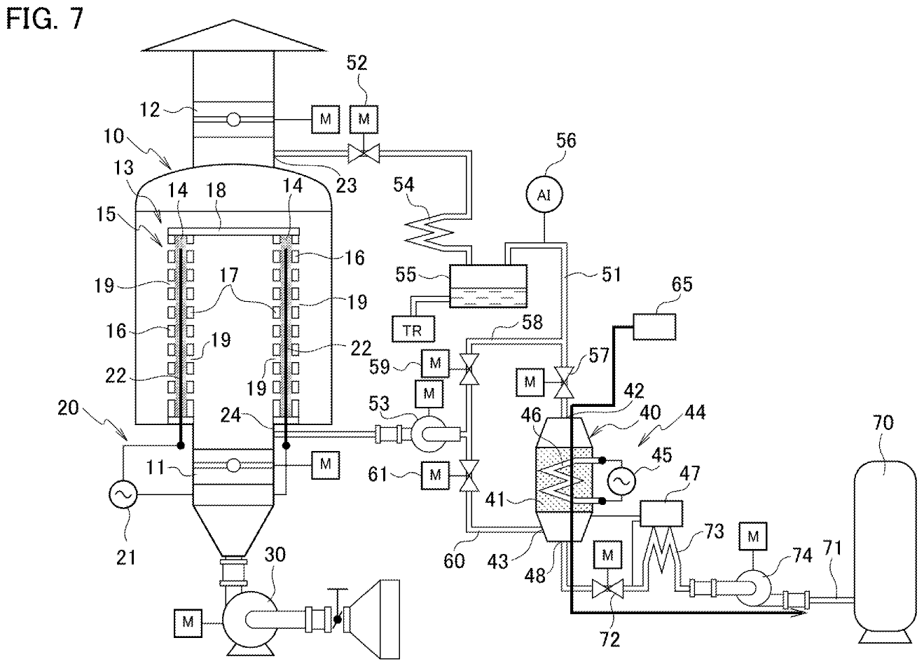

As illustrated in FIG. 7, when the second concentrated gas is generated, the opening and closing valve 72 is opened, and purge gas is supplied from the gas supply unit 65 to the second adsorption tower 40. The purge gas promotes the desorption of carbon dioxide from the second adsorbent 41. The second concentrated gas is discharged from the second adsorption tower 40 through the outlet 48, passes through the piping 71 and is recovered by the recovery unit 70.

As described above, the carbon dioxide recovery system 1 according to the present embodiment includes the first adsorption tower 10 containing the first adsorbent 14 and including the first heating unit 20 for heating the first adsorbent 14, and the second adsorption tower 40 containing the second adsorbent 41 and including the second heating unit 44 for heating the second adsorbent 41. When the first adsorbent 14 comes into contact with air supplied from the outside of the first adsorption tower 10, the first adsorbent 14 adsorbs carbon dioxide in the air. When the first adsorbent 14 is heated by the first heating unit 20, carbon dioxide which has been adsorbed on the first adsorbent 14 is desorbed, and the first concentrated gas is generated which contains carbon dioxide desorbed from the first adsorbent 14 and has a carbon dioxide concentration higher than that of air. When the second adsorbent 41 comes into contact with the first concentrated gas supplied from the first adsorption tower 10, the second adsorbent 41 adsorbs carbon dioxide in the first concentrated gas. When the second adsorbent 41 is heated by the second heating unit 44, carbon dioxide which has been adsorbed on the second adsorbent 41 is desorbed, and the second concentrated gas is generated which contains carbon dioxide desorbed from the second adsorbent 41 and has a higher carbon dioxide concentration than that of the first concentrated gas.

The method for recovering carbon dioxide according to the present embodiment includes a step of causing, through contact with air supplied from the outside of the first adsorption tower 10, carbon dioxide in the air to be adsorbed on the first adsorbent 14 contained in the first adsorption tower 10. The above method includes a step of causing carbon dioxide which has been adsorbed on the first adsorbent 14 to be desorbed through heating and generating a first concentrated gas that contains carbon dioxide desorbed from the first adsorbent 14 and has a carbon dioxide concentration higher than that of air. The above method includes a step of causing, through contact with the first concentrated gas supplied from the first adsorption tower 10, carbon dioxide in the first concentrated gas to be adsorbed on the second adsorbent 41 contained in the second adsorption tower 40. The above method includes a step of causing carbon dioxide which has been adsorbed on the second adsorbent 41 to be desorbed through heating and generating a second concentrated gas that contains carbon dioxide desorbed from the second adsorbent 41 and has a carbon dioxide concentration higher than that of the first concentrated gas.

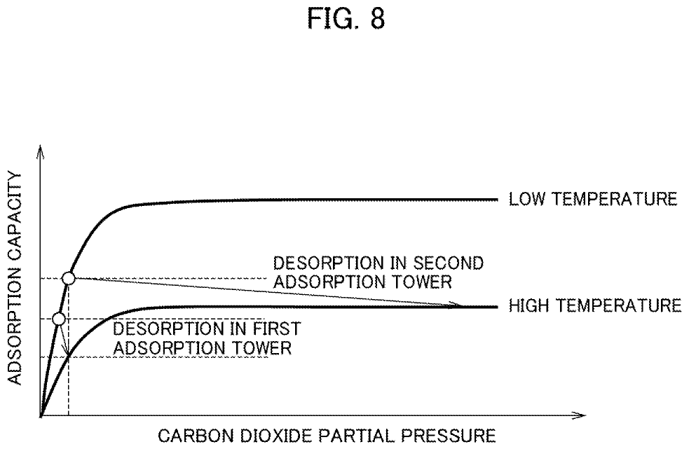

FIG. 8 is a graph illustrating a relationship between the partial pressure of carbon dioxide and the adsorption capacity of carbon dioxide when an adsorbent is heated to a high temperature and to a low temperature. As illustrated in FIG. 8, the adsorption capacity of the adsorbent becomes larger as the partial pressure of carbon dioxide is greater. However, the concentration of carbon dioxide in air is about 400 ppm, and the partial pressure of carbon dioxide is not high. Thus, even if carbon dioxide in air is made adsorbed on an adsorbent and then desorbed through heating to generate a first concentrated gas, the first concentrated gas having a sufficiently high concentration of carbon dioxide cannot be obtained. In contrast, when the carbon dioxide in the first concentrated gas is made adsorbed on the adsorbent again, the adsorption amount of carbon dioxide increases, and thus a second concentrated gas having a high concentration of carbon dioxide can be obtained by desorbing carbon dioxide through heating.

Therefore, in the carbon dioxide recovery system 1 and the method for recovering carbon dioxide according to the present embodiment, it is possible to reduce energy required for depressurization when carbon dioxide is desorbed from the adsorbent.

Note that in the carbon dioxide recovery system 1 according to the present embodiment, an example in which the first adsorption tower 10 and the second adsorption tower 40 have different configurations has been described. However, the first adsorption tower 10 and the second adsorption tower 40 may have the same configuration.

In the carbon dioxide recovery system 1 according to the present embodiment, the blower 53 is provided in the piping 58. However, the position where the blower 53 is provided is not particularly limited, and the blower 53 may be provided in the piping 51 or the piping 58.

In the present embodiment, the second adsorption tower 40 is configured to cause the first concentrated gas to flow therethrough from the upper side to the lower side. However, the second adsorption tower 40 may be configured to cause the first concentrated gas to flow therethrough from the lower side to the upper side.

Although the present embodiment describes an example in which the carbon dioxide recovery system 1 includes one first adsorption tower 10, the carbon dioxide recovery system 1 may include multiple first adsorption towers 10 arranged in parallel. Thus, for example, while carbon dioxide is adsorbed in one first adsorption tower 10, carbon dioxide can be desorbed in another first adsorption tower 10. Therefore, it is possible to improve the carbon dioxide recovery efficiency of the carbon dioxide recovery system 1.

In the carbon dioxide recovery system 1 according to the present embodiment, an example of recovering carbon dioxide using two adsorption towers, the first adsorption tower 10 and the second adsorption tower 40, has been described. However, the carbon dioxide recovery system 1 may include three or more adsorption towers. For example, the carbon dioxide recovery system 1 may include the first adsorption tower 10 for generating a first concentrated gas, the second adsorption tower 40 for generating a second concentrated gas by concentrating the first concentrated gas, and a third adsorption tower (not illustrated) for generating a third concentrated gas by concentrating the second concentrated gas.

### EXAMPLES

Hereinafter, the present embodiment will be described in more detail with the following examples, but the present embodiment is not limited to these examples.

An adsorbent is filled in a cylindrical container provided with an inlet and an outlet. The weight of the adsorbent filled is 1.7 g. As the filler, Lewatit (registered trademark) VP OC 1065 manufactured by LANXESS was used. The adsorbent is a porous body whose matrix is a polymer and has a primary amine as a functional group. A heater for heating the adsorbent was attached to the outer periphery of the container.

Next, as operation 1, the temperature in the container was set to 25° C., and air having a carbon dioxide concentration of 0.04% by volume was passed through the container at a flow rate of 3.8 slm (standard liter per minute) to cause carbon dioxide in the air to be adsorbed on the adsorbent.

After operation 1, as operation 2, the temperature in the container was set to 140° C., and air having a carbon dioxide concentration of 0.04% by volume was passed through the container at a flow rate of 0.05 slm to desorb carbon dioxide from the adsorbent.

After operation 2, as operation 3, the temperature in the container was set to 25° C., and air having a carbon dioxide concentration of 0.04% by volume was passed through the container at a flow rate of 3.8 slm to cause carbon dioxide in the air to be adsorbed on the adsorbent.

After operation 3, as operation 4, the temperature in the container was set to 25° C., and a gas having a carbon dioxide concentration of 10% by volume was passed through the container at a flow rate of 0.5 slm to cause carbon dioxide in the gas to be adsorbed on the adsorbent.

After operation 4, as operation 5, the temperature in the container was set to 140° C., and air having a carbon dioxide concentration of 0.04% by volume was passed through the container at a flow rate of 0.05 slm to desorb carbon dioxide from the adsorbent.

### Evaluation

The carbon dioxide peak concentration in the gas obtained in operation 2 and operation 5 was measured. The amount of carbon dioxide adsorbed on and desorbed from the adsorbent was also measured. Table 1 shows these results.

TABLE 1

| | | Temper- | Flow | Inlet CO₂ | Outlet CO₂ | Adsorption | Desorption |
|---|---|---|---|---|---|---|---|
| | | ature | rate | concentration | peak concentration | amount | amount |
| Operation | | [° C.] | [slm] | [%] | [%] | [g_CO2/kg] | [g_CO2/kg] |
| Operation 1 | Adsorption | 25 | 3.8 | 0.04 | — | 15 | — |
| Operation 2 | Desorption | 140 | 0.05 | 0.04 | 30 | — | 15 |
| Operation 3 | Adsorption | 25 | 3.8 | 0.04 | — | 15 | — |
| Operation 4 | Adsorption | 25 | 0.5 | 10 | — | 44 | — |
| Operation 5 | Desorption | 140 | 0.05 | 0.04 | 100 | — | 44 |

As illustrated in Table 1, the carbon dioxide concentration of the gas obtained from the outlet increased from 30% in operation 2 to 100% in operation 5. These results indicate that the carbon dioxide concentration of the desorbed gas can be increased by repeating adsorption and desorption as in operations 1 to 5. In this example, it was confirmed that the peak concentration of carbon dioxide was concentrated from 30% to 100% by using the same adsorption device and adsorbent. However, it is thought that carbon dioxide can be concentrated even when the adsorption device used in operations 1 and 2 is made smaller than the volume of the adsorption device used in operations 4 and 5. Therefore, it can be seen that carbon dioxide in the air can be recovered without depressurizing the inside of the adsorption towers by using multiple adsorption towers as in the above-described embodiment. Similarly, it can be seen that carbon dioxide in the air can be recovered through the two-step adsorption and desorption without depressurizing the inside of the adsorption tower.

Although some embodiments have been described, modifications and variations thereof are possible based on the above-described disclosure. All components of the above embodiments and all features described in the claims may be individually extracted and combined as long as they do not conflict with each other.

The present disclosure can contribute, for example, to goal 7 “Ensure access to affordable, reliable, sustainable and modern energy for all”, and goal 13 “Take urgent action to combat climate change and its impacts” of the Sustainable Development Goals (SDGs) led by the United Nations.

What is claimed is:

1. A carbon dioxide recovery system, comprising:
a first adsorption tower that contains a first adsorbent and includes a first heating unit for heating the first adsorbent; and
a second adsorption tower that contains a second adsorbent and includes a second heating unit for heating the second adsorbent, wherein
when brought into contact with air supplied from outside of the first adsorption tower, the first adsorbent adsorbs carbon dioxide in the air and when heated by the first heating unit, desorbs carbon dioxide which has been adsorbed thereon, and a first concentrated gas that contains carbon dioxide desorbed from the first adsorbent and has a carbon dioxide concentration higher than that of the air is generated, and
when brought into contact with the first concentrated gas supplied from the first adsorption tower, the second adsorbent adsorbs carbon dioxide in the first concentrated gas and when heated by the second heating unit, desorbs carbon dioxide which has been adsorbed thereon, and a second concentrated gas that contains carbon dioxide desorbed from the second adsorbent and has a carbon dioxide concentration higher than that of the first concentrated gas is generated.

2. The carbon dioxide recovery system according to claim 1, wherein the second adsorption tower has a smaller volume than that of the first adsorption tower.

3. The carbon dioxide recovery system according to claim 1, further comprising: a depressurization unit that depressurizes inside of the second adsorption tower.

4. The carbon dioxide recovery system according to claim 1, further comprising: a gas supply unit that supplies to the second adsorption tower at least one type of purge gas selected from the group consisting of air, hydrogen, water vapor, and an inert gas.

5. The carbon dioxide recovery system according to claim 1, wherein a bulk density of the second adsorbent is greater than or equal to that of the first adsorbent.

6. The carbon dioxide recovery system according to claim 1, wherein a bulk density of the second adsorbent is less than that of the first adsorbent.

7. The carbon dioxide recovery system according to claim 1, further comprising:
a concentration measuring unit that measures a concentration of carbon dioxide in the first concentrated gas, wherein
the first concentrated gas discharged from the first adsorption tower is introduced into the first adsorption tower in accordance with the concentration of carbon dioxide measured by the concentration measuring unit.

8. The carbon dioxide recovery system according to claim 1, wherein the first concentrated gas which has come into contact with the second adsorbent is supplied to the first adsorption tower, comes into contact with the first adsorbent, and promotes desorption of the carbon dioxide which has been adsorbed on the first adsorbent.

9. The carbon dioxide recovery system according to claim 8,
wherein a gas which has been supplied from the second adsorption tower and has come into contact with the first adsorbent is supplied to the second adsorption tower, and
wherein the carbon dioxide in the gas which has been supplied from the second adsorption tower and has come into contact with the first adsorbent is adsorbed on the second adsorbent.

10. A method for recovering carbon dioxide, comprising:
a step of causing, through contact with air supplied from outside of a first adsorption tower, carbon dioxide in the air to be adsorbed on a first adsorbent contained in the first adsorption tower;
a step of causing carbon dioxide which has been adsorbed on the first adsorbent to be desorbed through heating and generating a first concentrated gas that contains carbon dioxide desorbed from the first adsorbent and has a carbon dioxide concentration higher than that of the air;
a step of causing, through contact with the first concentrated gas supplied from the first adsorption tower, carbon dioxide in the first concentrated gas to be adsorbed on a second adsorbent contained in a second adsorption tower; and
a step of causing carbon dioxide which has been adsorbed on the second adsorbent to be desorbed through heating and generating a second concentrated gas that contains carbon dioxide desorbed from the second adsorbent and has a carbon dioxide concentration higher than that of the first concentrated gas.
